(19) United States
(12) Patent Application Publication
(10) Pub. No.: US 2026/0133765 A1
(43) Pub. Date: May 14, 2026

(54) LLM-GENERATED STACK DESIGN

(71) Applicant: ORACLE INTERNATIONAL CORPORATION, Redwood Shores, CA (US)

(72) Inventors: Paul Gregory GREENSTEIN, Hopkinton, MA (US); Zbigniew HOLKA, Solihull (GB)

(21) Appl. No.: 18/946,209

(22) Filed: Nov. 13, 2024

(51) Int. Cl. G06F 8/20

(52) U.S. Cl. CPC G06F 8/20

(57) ABSTRACT

Systems, methods, and other embodiments associated with LLM generation of solution stacks for software solutions are described. In one embodiment, an example method includes accessing a solution definition for a software solution. The solution definition is in human language. The example method includes generating a logical solution topology from the solution definition using a large language model. The example method includes generating a physical solution topology from the solution definition and the logical solution topology using the large language model. And, the example method includes translating the physical solution topology into a stack specification. The stack specification describes a solution stack for creation and implementation of the software solution. The stack specification includes a deployment specification, an implementation plan, and a development plan.

### BACKGROUND

Cloud platforms have become popular tools for hosting software applications due to their adaptability, scalability, and accessibility. While the computing environment of a cloud platform is largely virtualized, clients of the cloud platform are tasked with the planning, configuration, and development of the solution stacks that execute the client's solution. The processes for planning, configuration, and development of the solution stacks are inconsistent, and are resistant to automation due to the open-ended nature of the design process.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a stack generation system that is associated with generation and deployment of solution stacks for software solutions using LLMs.

FIG. 2 illustrates one embodiment of a stack generation method that is associated with generation and deployment of solution stacks for software solutions using LLMs.

FIG. 3 illustrates one embodiment of a software deployment method that is associated with generation and deployment of solution stacks for software solutions using LLMs.

FIG. 4 illustrates one embodiment of a custom code generation method that is associated with generation and deployment of solution stacks for software solutions using LLMs.

FIG. 5 illustrates one embodiment of a custom code collection method that is associated with generation and deployment of solution stacks for software solutions using LLMs.

FIG. 6 illustrates one embodiment of a topology validation method that is associated with generation and deployment of solution stacks for software solutions using LLMs.

FIG. 7 illustrates one embodiment of a stack generation process that is associated with generation and deployment of solution stacks for software solutions using LLMs.

FIG. 8 illustrates an embodiment of a computing system configured with the example systems and/or methods disclosed.

### DETAILED DESCRIPTION

Systems and methods are described herein that provide for generation and deployment of solution stacks for software solutions by large language models (LLMs). In one embodiment, a stack generation system employs one or more LLMs to automatically generate and deploy a solution stack that implements a software solution. In one embodiment, the stack generation system generates the solution stack by generating the technology stack, specifying the software stack, identifying custom software, integration points, and customization points, and accepting feedback to ensure the solution conforms to the solution definition.

In one embodiment, the stack generation system improves over existing processes for solution development by providing end-to-end, definition-to-deployment automation of the solution development process. This enables organizations to rapidly develop and deploy a software solution based on input of a human-language solution definition. In one embodiment, the stack generation system improves over existing processes for solution development by automatically detecting and setting aside for human intervention portions of the development process which are not automatable, and performing those portions of the development that are automatable. In one embodiment, the stack generation system improves over existing processes by enhancing accuracy, consistency, and predictability of solution stack designs due to employment of LLMs to design the compute stacks.

### Definitions

As used herein, the term “solution stack” refers to a collection of software subsystems, technologies, tools, and hardware infrastructure that are used to create and operate a software solution. The solution stack represents the environment for development, deployment, and operation of the software solution. The solution stack encompasses both a software stack and a technology stack for the software solution.

As used herein, the term “software stack” refers to a collection of software components or layers that cooperate to form a software solution. For example, a software stack may include: an operating system that serves as a foundational layer that manages hardware resources; middleware that connects different applications or services, such as web servers or application servers; runtime environments that provide platforms for software to run, such as Java Virtual Machine or programming-language-specific runtime environments; databases that are systems that store and manage data; and application software that provides an application or service to a client or user. The software stack thus provides an execution environment to run the software solution effectively.

As used herein, the term “technology stack” refers to a collection of software and hardware technologies used to develop, deploy, and/or maintain a software solution. For example, a technology stack may include, programming languages that are used to write code of one or more applications of the software solution, such as Python, JavaScript, Java, C#, or C; language runtime environments; frameworks and libraries that have pre-written code used to streamline development of the software solution; development tools that are used in the development process such as IDEs (Integrated Development Environments), compilers, interpreters, artefact repositories, and version control systems; APIs (Application Programming Interfaces) and services that are integrated into the software solution; infrastructure and platforms, like Oracle Cloud Infrastructure (OCI), Amazon Web Services (AWS), Microsoft Azure, Google Cloud Platform (GCP); cloud services, such as business intelligence services (e.g., Oracle Analytics Cloud, Amazon QuickSight, Microsoft Power BI, Google Looker, Tableau, SAP Analytics Cloud, IBM Cognos Analytics), blockchain services (e.g., Oracle Blockchain Cloud Service, Amazon Managed Blockchain, Microsoft Azure Blockchain Service, SAP Blockchain Service, IBM Blockchain Platform), Conversational AI and Chatbot services (e.g., Oracle Digital Assistant, Amazon Lex, Microsoft Azure Bot Service, Google Dialogflow, IBM Watson Assistant, SAP Conversational AI), and many other cloud services; cloud services, such as Oracle Analytics Cloud, Oracle Blockchain Cloud Service, Oracle Digital Assistant, etc., monitoring and alerting functions; and containerization tools like Docker and Kubernetes.

As used herein, the term “software solution” refers to a software application, software program, or software service configured to perform one or more defined tasks.

As used herein, “solution topology” refers to a description of component configuration in a computing system as one or more graphs (or collection of textual tokens translatable to one or more graphs).

As used herein, “Logical Solution Topology” (LST) refers to a graph (or collection of textual tokens translatable to a graph) that represents an architecture of a software solution, focusing on the relationships and interactions between different functional elements or components. An LST serves as a blueprint that outlines logical structure and behavior of the software solution, independent of the underlying software and technology stack that will implement it.

As used herein, “Physical Solution Topology” (PST) refers to a graph (or collection of textual tokens translatable to a graph) that represents solution stack for a software solution. For example, the PST may be a superposition of several independent graph views of the solution, including installation, dependencies (installation, operational, functional, etc.), data flow, and functional flow graphs. A PST serves as a mapping of the LST onto a technology and software stack that is configured to implement the software solution.

Note, both LSTs and PSTs may be referred to generally herein as “graphs.”

As used herein, “solution definition” is a specification of what the software solution will entail. For example, the solution definition includes functional requirements, non-functional requirements, system architecture design, and solution stack selection (including selection of technology stacks and software stacks). The solution definition may be expressed in human language in a definition document. For example, the solution definition may describe the software solution with human language to a level of detail sufficient to enable automated development and deployment of the software solution.

As used herein, “human language” refers to natural, everyday language used by people to communicate, including written text or spoken dictation that is used to express solution requirements for compute infrastructure. Human language includes, but is not limited to, written and typewritten forms of text that are converted into electronic data, spoken dictation that is received by a computing device and converted into electronic data, and text extracted from spoken dictation using voice-to-text conversion and/or speech recognition technology. An item of electronic data (such as a changed solution requirement) is “in human language” where the electronic data expresses, records, defines, stores, or otherwise represents textual (written) or vocal (spoken) human language.

As used herein, the terms “computing infrastructure” and “compute infrastructure” (occasionally referred to herein simply as “infrastructure” for short) refers to a collection of hardware, software, networks, facilities, and related services that deliver information technology operations.

No action or function described or claimed herein is performed by the human mind. An interpretation that any action or function can be performed in the human mind is inconsistent with and contrary to this disclosure.

### Example Stack Generation System

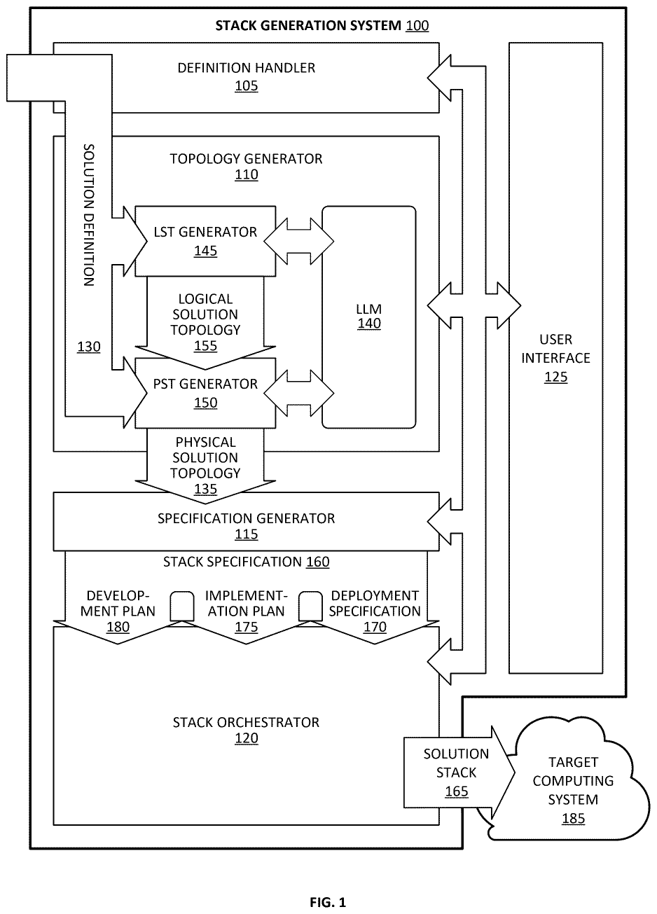

FIG. 1 illustrates one embodiment of a stack generation system 100 that is associated with generation and deployment of solution stacks for software solutions using LLMs. Stack generation system 100 includes components configured to implement an LLM-based process for automatically generating a physical solution topology and specification for a solution stack to implement the software solution. In one embodiment, stack generation system 100 includes a definition handler 105, a topology generator 110, and a specification generator 115. In one embodiment, the stack generation system 100 may further include a stack orchestrator 120. In one embodiment, the stack generation system 100 may further include a user interface 125.

In one embodiment, definition handler 105 is configured to access a solution definition 130 for a software solution. The solution definition 130 is in human language. For example, the solution definition 130 may be human language text or voice descriptions of features of the software solution. The solution definition 130 may include functional requirements: descriptions of the functions, behaviors, actions, or tasks the software solution is to perform. Functional requirements are considered when generating an LST. And, for example, the solution definition 130 may include non-functional requirements: descriptions of criteria, constraints, and quality attributes that affect the implementation of the functions, behaviors, actions, or tasks to be performed by the software solution. Non-functional requirements are considered when generating a PST.

In one embodiment, topology generator 110 is configured to generate a PST 135 using an LLM 140. In one embodiment, topology generator 110 includes an LST generator 145 and a PST generator 150. LST generator 145 is configured to generate an LST 155 from the solution definition 130 using LLM 140 as an intermediate step to generation of PST 135. PST generator 150 is configured to generate PST 135 from the solution definition 130 and the LST 155 using LLM 140. In one embodiment, LST generator 145 and a PST generator 150 are configured to prompt LLM 140 to generate solution topologies (such as LST 155 and PST 135) as a series of tokens in a graph representation language (GRL).

In one embodiment, LLM 140 is a generative artificial intelligence (AI) model. For example, the LLM 140 may be a Cohere LLM, or a ChatGPT LLM. Other LLMs may also be suitable. LLM 140 is configured to accept prompts to generate LSTs from LST generator 145 and prompts to generate PSTs from PST generator 150, for example, by way of an API endpoint for receiving chat prompts. LLM 140 is trained to respond to prompts to generate graphs or topologies in GRL code—that is, as a series of tokens in a GRL—that express the nodes (entities) and edges (relationships) of the graph or topology. In one embodiment, LLM 140 has been trained to generate LSTs (such as LST 155) based on a provided solution definition (such as solution definition 130). In one embodiment, LLM 140 has been trained to generate PSTs (such as PST 135) based on a provided solution definition (such as solution definition 130) and a provided LST (such as LST 155).

In one embodiment, specification generator 115 is configured to translate the PST 135 into a stack specification 160. The stack specification 160 describes a solution stack 165 for creation and implementation of the software solution. The stack specification 160 includes a deployment specification 170, a implementation plan 175, and a development plan 180. In one embodiment, deployment specification 170 is executable deployment code (such as YAML or HCL code) for configuring compute infrastructure. In one embodiment, solution implementation plan 175 states the steps, resources, timelines, and/or strategies to implement the software solution. In one embodiment, development plan 180 defines functionality and features of custom code for implementation of the software solution.

In one embodiment, stack orchestrator 120 is configured to orchestrate deployment of the solution stack 165 to a target computing system 185 to configure the target computing system 185 to execute the software solution. In one embodiment, the stack orchestrator 120 is configured to automatically configure target computing system 185 to have (i) infrastructure as specified the deployment specification 170, and (ii) software configured as specified by the implementation plan 175, including custom software as specified by the development plan 180. In one embodiment, stack orchestrator 120 is configured to execute the deployment specification 170 to configure compute infrastructure of target computing system 185 in accordance with the solution stack 165. In one embodiment, stack orchestrator 120 is configured to analyze the solution implementation plan 175 to extract automatable tasks, convert the automatable tasks into executable code, and execute the executable code to configure and deploy software onto the configured compute infrastructure of target computing system 185 in accordance with the solution stack 165. In one embodiment, stack orchestrator 120 is configured to analyze the development plan 180 to detect functionality and features of custom software (including, for example, source code, binary code, or other software components for execution or interpretation by an appropriate interpreter or executor), dynamically generate prompts configured to cause an LLM to generate the custom software to perform the functionality and features, automatically submit the prompts to the LLM and collect the responses by the LLM to the prompts as the custom software, and add the custom software to the implementation plan 175. The custom software may also be written by a human to implement the detected required—but unavailable—functionality and features, and then added to the implementation plan 175.

In one embodiment, user interface 125 is configured to present outputs of the stack generation system 100 and accept inputs from a user of the stack generation system 100. In one embodiment, the user interface 125 is a graphical user interface (GUI). In one embodiment, the user interface 125 may be a GUI that is duplex, that is, a user interface that supports two-way communication between the user and infrastructure modification system 100 in real time or near real time. For example, user interface 125 may be shown on a display of a computer terminal and may be configured to accept inputs from the user that are entered through the computer terminal.

In one embodiment, user interface 125 may be configured to present a solution topology (such as LST 155 or PST 135) visually in the GUI on the display of the computer terminal. In one embodiment, presenting a solution topology in user interface 125 includes parsing the GRL code of the solution topology to identify entities and relationships between the entities. And, once the entities and relationships are detected, presentation further displays the entities as nodes interconnected by edges representing the relationships between the entities.

PST 135 may be a superposition graph in which an infrastructure topology, including network topology, an installation topology, a data flow topology, a functional flow topology, and an availability and performance topology are merged. Note that availability and performance topology describes elements to be replicated or clustered in the software solution to achieve availability and/or performance that is specified (for example in solution definition 130). This may be deemed too visually complex for user comprehension. Accordingly, in one embodiment, PST 135 may be shown in discrete layers for the component topologies. A layer of a topology shows nodes and edges associated with one component topology or one type of component or function-related topology (aspect), while hiding nodes and edges associated with other component topologies or aspects. For example, user interface 125 may show PST 135 in the GUI with nodes and edges of the network and installation topology visible, and the nodes and edges of the data flow, the functional flow, and the availability and performance topologies invisible. In one embodiment, in response to selection for display or hiding by the user, one or more layers of PST 135 may be shown at a time in the GUI. In one embodiment, the user interface may be configured to show discrete layers of PST 135 using distinct colors, highlighting, or other visual designation for the component topologies.

In one embodiment, user interface 125 is configured to present LST 155 for user approval before continuing to generation of PST 135 from LST 155 and solution definition 130. And, in one embodiment, user interface 125 is configured to present PST 135 for user approval before continuing to generation of stack specification 160 from PST 130. In one embodiment, user interface 125 is configured to solicit user inputs such as approvals or corrections regarding a topology presented in user interface 125. For example, user interface 125 may include text boxes, selection controls (such as dropdown menus, radio buttons, checkboxes, and toggle switches). The user interface 125 may be configured to accept corrections, adjustments, or other changes to aspects of entities and relationships through user interface elements that are associated with the entities and relationships. In one embodiment, the user interface 125 is configured to enable the user to remove, add, or edit entities and relationships, and further to enable the user to rearrange the relationships between entities. The GUI may be configured to allow a user to interactively modify the infrastructure graph, for example by drag-and-drop of visual elements (such as nodes and edges) of the solution topology.

In one embodiment, target computing system 185 is physical compute infrastructure (i.e., a hardware environment) that is configurable with a solution stack by stack orchestrator 120 to implement a software solution. For example, target computing system 185 is a cloud computing system, such as (i) a public cloud operated by a third-party cloud service provider, (ii) a private cloud operated on premises of the enterprise client; or (iii) a hybrid cloud that incorporates resources both on premises of the enterprise client and in the environment of one or more cloud service providers, in any combination. In one embodiment, target computing system 185 is a virtualized on-premises data center. (Note, in one embodiment, the algorithms described herein for LST, PST, and stack generation are also applicable to non-virtualized environments, although subsequent infrastructure orchestration to deploy the infrastructure of the stack to the target computing system rely on virtualization). Target computing system 185 includes computing hardware components that inter-operate to provide computing resources. For example, target computing system 185 includes one or more bare metal computer servers (which include physical processors, memory, and non-transitory computer-readable storage media) interconnected by a physical data network. Such compute infrastructure components may be provisioned atop the underlying bare metal hardware of target computing system 185.

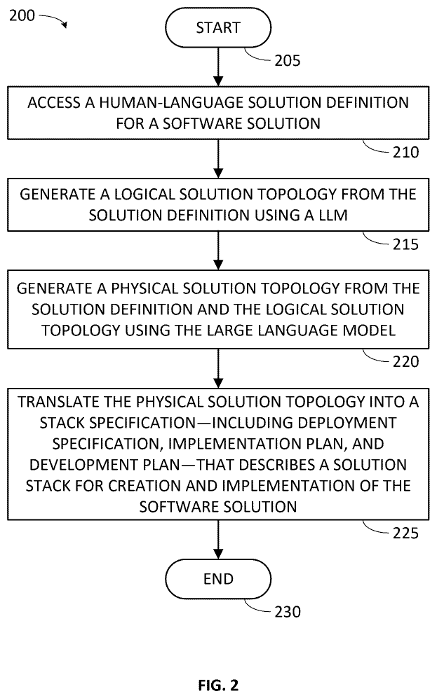

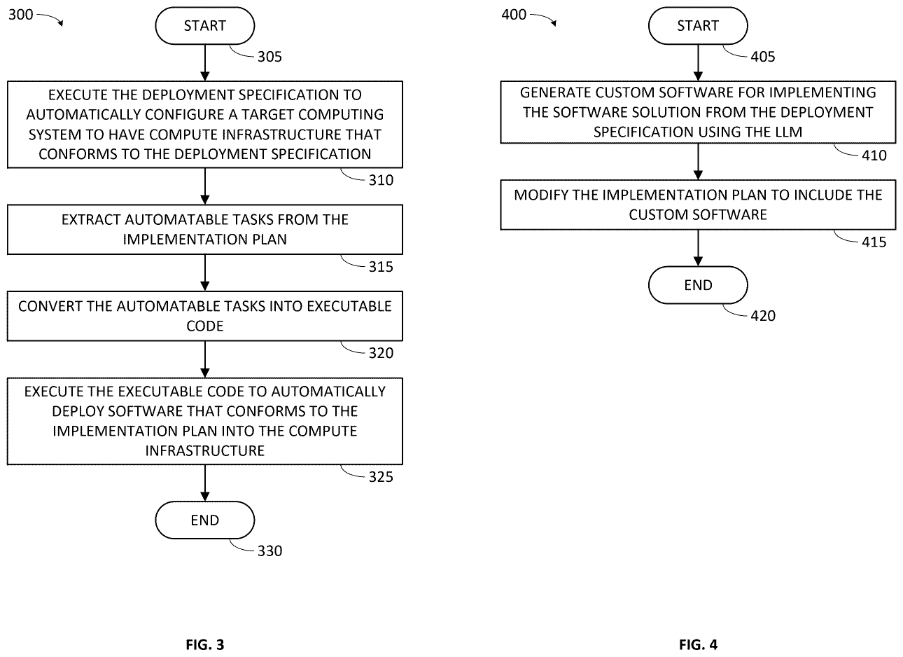

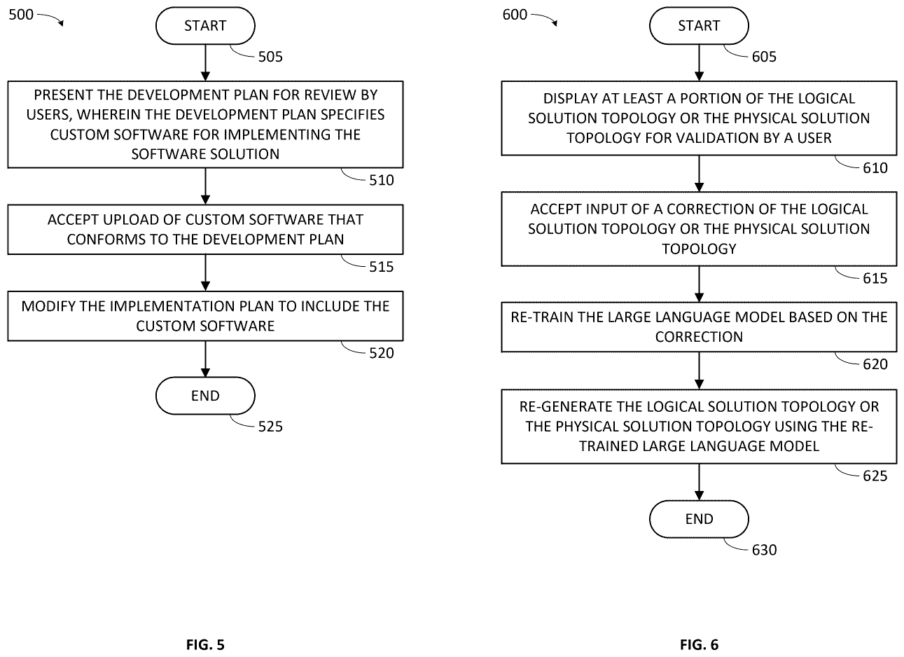

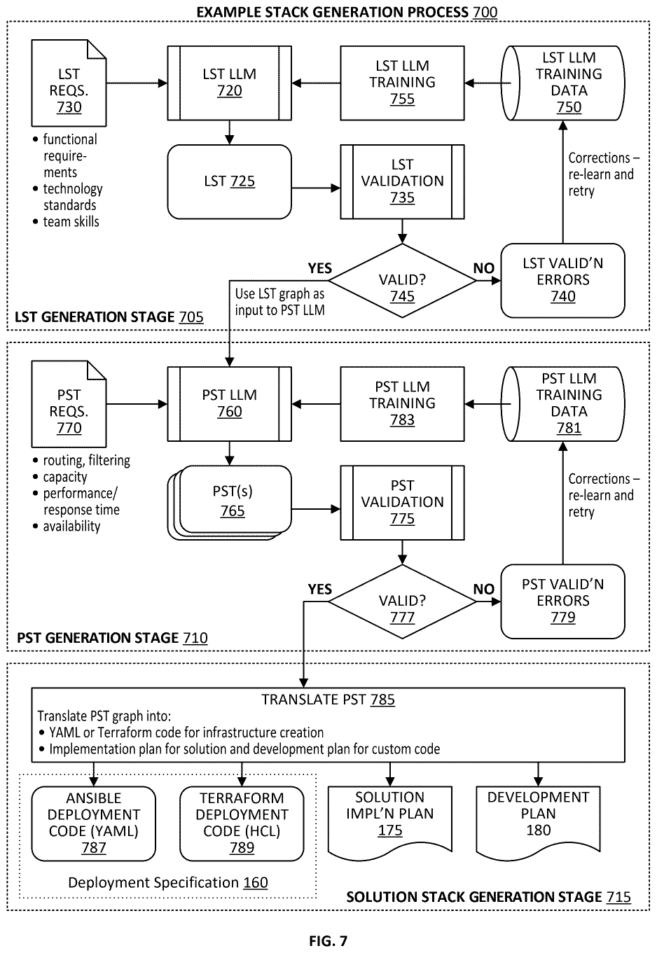

Further details regarding stack generation system 100 are presented herein. In one embodiment, operations of stack generation system 100 will be described with reference to stack generation method 200 of FIG. 2 and stack generation process 700 of FIG. 7. In one embodiment, operations of stack generation system 100 to automatically deploy software that conforms to implementation plan 175 will be described with reference to software deployment method 300 of FIG. 3. In one embodiment, operations of stack generation system 100 to add custom software to the implementation plan 175 will be described with reference to custom code generation method 400 of FIG. 4 and custom code collection method 500 of FIG. 5. In one embodiment, operations of stack generation system 100 for validation of infrastructure topologies will be described with reference to topology validation method 600 of FIG. 6.

### Example Stack Generation Method

FIG. 2 illustrates one embodiment of a stack generation method 200 that is associated with generation and deployment of solution stacks for software solutions using LLMs. Stack generation method 200 is one method for automatically generating and implementing a solution stack in a target computing system 185 from a solution definition that is in human language form or format.

In one embodiment, as a general overview, stack generation method 200 accesses the solution definition 130, uses an LLM 140 to generate a PST 135 from the solution definition 130, and generates a stack specification 160 that details a solution stack 135 for deployment on a target computing system 185. In one embodiment, stack generation method 200 generates an LST 155 from the deployment specification 130 as an intermediate step of generating the PST 135. In one embodiment, stack generation method 200 further orchestrates deployment of the solution stack to the target computing system 185.

In one embodiment stack generation method 200 initiates at START block 205 in response stack generation system 100 determining one or more of (1) that stack generation system 100 has received an instruction to configure a target computer system as described by a provided solution definition; (2) that stack generation system 100 has received an instruction to generate a stack specification from a provided solution definition; (3) stack generation system 100 has received a solution definition for a software solution that is in human; (4) that an instruction to perform stack generation method 200 has been received; (5) a user or administrator has initiated stack generation method 200; (6) it is currently a time at which stack generation method 200 is scheduled to be run; or (7) stack generation method 200 should commence in response to satisfaction of some other condition. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of stack generation system 100 executes stack generation method 200. In one embodiment, at START block 205, stack generation system 100 (1) provisions (i.e., allocates and initializes) resources of the computing system that are used by stack generation system 100, such as processor, memory and storage (for example, for holding outputs like the generated solution topologies and stack specification), (2) establishes access to one or more networks for the resources, such as access to (a) internal networks for communication among components of the stack generation system 100 and (b) external networks for communication with other computing systems (for example, the target computing system); (3) connects to data sources (such as databases, data stores, file systems, and cloud storage) used by the stack generation method 200, such as data sources that hold the input solution definition and trained LLM(s) and (4) configures the computing system with system settings, software dependencies and libraries, and modules for the components of stack generation system 100. Following initiation at START block 205, stack generation method 200 proceeds to block 210.

At block 210, stack generation method 200 accesses a solution definition 130 for a software solution. The solution definition 130 is in human language. In one embodiment, stack generation method 200 is provided with a pre-specified set of requirements and architecture in the solution definition 130. The solution definition may be provided in a file located at a provided file path, as a specified record in a database, or received by input through user interface 125. In one embodiment, stack generation method 200 retrieves the solution definition 130 from its location in storage, and formats the solution definition 130 for use by downstream processes. In short, the infrastructure production method 200 reads, retrieves, or otherwise gets a statement of the features of a software solution.

Because the solution definition 130 is in human language, the solution definition may therefore be informal, and not necessarily follow a particular structure. In one embodiment, the solution definition 130 is stored as electronic data in a data structure capable of storing human language text, such as a text file, Word document file, PDF file, and so on. In one embodiment, the solution definition 130 is stored as electronic data in a data structure capable of storing human language dictation, such as an audio or audio-video file in one of many formats such as MP3 (MPEG-1 Audio Layer III), WAV (Waveform Audio File Format), AAC (Advanced Audio Coding), AIFF (Audio Interchange File Format), OGG (Ogg Vorbis), MP4 (MPEG-4 Part 14), AVI (Audio Video Interleave), MKV (Matroska Video File), other MPEG formats, and so on.

In one embodiment, stack generation method 200 accesses a solution definition 130 for a software solution by locating and retrieving the solution definition. For example, to locate and retrieve solution definition 130, stack generation method 200 (i) obtains the storage location for the solution definition 130, for example by receiving the storage location as an input to a user interface 125; (ii) accesses the storage location (e.g., file system, database, or cloud storage) where the solution definition 130 of the compute infrastructure is saved; and (iii) loads the solution definition 130 into memory for subsequent processing.

In one embodiment, the steps of block 210 are performed by definition handler 105. At the conclusion of block 210, stack generation method 200 has made the solution definition 130 available for downstream processing. Processing continues to block 215.

At block 215, stack generation method 200 generates an LST 155 from the solution definition 130 using an LLM 140. In one embodiment, stack generation method 200 translates the solution definition 130 into LST 155 using an LLM 140 that has been trained to generate LSTs. (Detail on training of LLM 140 is provided under the heading “Example LLM Training” below.) The LLM 140 interprets the solution definition 130 into a graph that represents the logical solution, the LST 155. The generation of LST 155 is an intermediate stage for translation of the solution definition 130 into PST 135.

In one embodiment, as an overview of block 215, stack generation method 200 accesses LLM 140, dynamically generates a prompt for generation of the LST based on the solution definition 130, submits the prompt to LLM 140, and then captures the LST from the response by LLM 140.

In one embodiment, stack generation method 200 may dynamically generate the prompt for generation of the LST 155 by loading and populating a template prompt for LST generation. A template prompt is a pre-defined text structure that includes placeholders or populatable fields that accept specific data at runtime. The template prompt serves as a blueprint for creating consistent, standardized inputs that are tailored to a task, such as the task of solution topology generation. The template prompt for LST generation may include, for example, an instruction to generate an LST in a given GRL with fields for items or features of the solution definition 130 that are relevant to generation of an LST. These items relevant to LST generation—referred to herein as LST requirements—include functional requirements of the software solution, technology standards for the software solution, and skills of the team tasked with implementing the solution. For example, the template prompt for LST generation may be something like:
Generate a logical solution topology in [Graph_Representation_Language] that satisfies the following functional requirements: [Functional_Requirements]
The logical solution topology should conform to the following technology standards: [Technology_Standards].
The logical solution topology should, to the extent possible, be within the following set of skills: [Team_Skills].

The prompt may be submitted by injecting the prompt into LLM 140 through a chat endpoint. For example, stack generation method 200 makes an API call to the API chat endpoint of the LLM 140: the prompt is placed in the payload of a request; and the request is passed (e.g., by HTTP POST) to the API chat endpoint of the LLM 140.

The LLM 140 processes the prompt. For example, LLM 140 tokenizes and embeds the prompt, applies attention mechanisms to focus on portions of the prompt that inform the design of the LST, and applies a trained understanding of the relationships between the prompt and the logical solution design to synthesize the LST 155. The LLM 140 may produce the LST as text, such as code in a GRL. Various GRLs may be appropriate for encoding a solution topology, including but not limited to: JSON-Graph, graph modeling language (GML), GraphML, Graphviz DOT, trivial graph format (TGF), and resource description framework (RDF). LLM 140 includes the GRL code of LST 155 in a response returned through the API chat endpoint.

In one embodiment, capturing a solution topology (such as LST 155 or PST 135) from a response involves reading or otherwise receiving the response from the API chat endpoint, parsing the response of the LLM 140 to extract the solution topology from other content of the response, and storing the extracted content for subsequent processing. For example, the stack generation method 200 may parse the response to retain content written in GRL code, and discard or disregard other content of the response.

In one embodiment, the steps of block 215 are performed by topology generator 110, including LST generator 145 and LLM 140. At the conclusion of block 215, stack generation method 200 has created an LST 155 for downstream use in generation of a PST 135. Processing continues to block 220.

At block 220, stack generation method 200 generates a PST 135 from the solution definition 130 and the LST 155 using the LLM. In one embodiment, stack generation method 200 translates the solution definition 130 and LST 155 into PST 135 using LLM 140 that has been trained to generate PSTs. (Detail on training of LLM 140 is provided under the heading “Example LLM Training” below.) The LLM 140 interprets the solution definition 130 and LST into a graph that represents the physical solution, the PST 135.

In one embodiment, as an overview of block 220, stack generation method 200 accesses LLM 140, dynamically generates a prompt for generation of the PST from the solution definition 130 and the LST 155, submits the prompt to the LLM 140, and then captures the response from the LLM 140.

In one embodiment, stack generation method 200 may dynamically generate the prompt for generation of the PST 135 by loading and populating a template prompt for PST generation. The template prompt for PST generation may include, for example, an instruction to generate an PST in a given GRL with fields for the LST and for items or features of the solution definition 130 that are relevant to generation of a PST. These items of the solution definition 130 that are relevant to PST generation—referred to herein as PST requirements—include non-functional requirements of the software solution such as routing and filtering, capacity, performance and response time, and availability requirements for the software solution. For example, the template prompt for PST generation may be something like:
Generate a physical solution topology in [Graph_Representation_Language] that follows the form of the following logical solution topology: [Logical_Solution_Topology].
Ensure that the physical solution topology satisfies the following non-functional requirements: [Non-Functional_Requirements]

As discussed above, the prompt may be provided to LLM 140 through a chat endpoint, and the LLM 140 processes the prompt. The LLM: (1) tokenizes and embeds the prompt, (2) applies attention mechanisms to focus on portions of the prompt that inform the design of the PST 135, and (3) applies a trained understanding of the relationships of the LST 155 and non-functional requirements with physical solution design to synthesize PST 135. The LLM 140 includes GRL code for PST 135 in a response returned through the API chat endpoint. Stack generation method 200 captures the PST 135.

In one embodiment, the steps of block 220 are performed by topology generator 110, including PST generator 150 and LLM 140. At the conclusion of block 220, stack generation method 200 has created a PST 135 for downstream uses in generation of a stack specification 160. Processing continues to block 225.

At block 225, stack generation method 200 translates the PST 135 into a stack specification 160. The stack specification 160 describes a solution stack 165 for creation and implementation of the software solution. The stack specification 160 includes a deployment specification 170, an implementation plan 175, and a development plan 180. As an example, stack generation method 200 may execute one or more scripts or other tools that that are configured to map the elements of PST 135 to syntaxes of the deployment specification 170, the implementation plan 175, and the development plan 180. Stack generation method 200 thus automates adaptation of the PST 135 to a stack specification 160 that includes automatable or executable tasks for deploying a solution stack 165.

In one embodiment, stack generation method 200 translates the elements (nodes and edges) of PST 135 to a deployment specification 170. For example, the translation may generate the deployment specification 170 in deployment code, such as a YAML Ansible playbook or an HCL Terraform configuration file. Stack generation method 200 parses PST 135 to identify, based on the elements of PST 135 what physical infrastructure components are included in the software solution and how the physical infrastructure components are connected in the software solution. Stack generation method 200 generates configuration blocks of infrastructure code for individual components. Stack generation method 200 then assembles the configuration blocks in a coherent order which, when executed, will result in compute infrastructure that conforms to the PST 135, thereby creating the deployment specification 170.

In one embodiment, stack generation method 200 translates the elements of PST 135 to an implementation plan 175. Stack generation method 200 parses PST 135 to obtain a list of the physical infrastructure components (i.e., hardware components, such as such as servers, network devices, and storage system) along with their respective functions, configurations, and interconnections. Stack generation method 200 maps the hardware components to their corresponding software components (for example, mapping physical servers to virtual machines or containers, mapping a network switch to a virtual network configuration). Stack generation method 200 organizes the software components into a sequence that accommodates the dependencies, conditions, and interactions outlined in PST 135. Stack generation method 200 then assembles these software components in the sequence into an implementation plan 175 that specifies provisioning, configuration, and deployment steps that will implement the functionality and connectivity of the PST 135.

In one embodiment, stack generation method 200 identifies gaps where existing software does not fulfill functionalities specified by PST 135, thereby determining where custom software is to be provided. Where the software components are programs (or other software) that already exist and are available, stack generation method 200 includes the existing programs, and associated configurations, in implementation plan 175. In one embodiment, where the software components are custom program that is not yet available, stack generation method 200 includes stubs or placeholders for the custom software in implementation plan 175. In one embodiment, if stubs or placeholders for custom software are created, the LLM may also generate an interface (or multiple) for each custom component, including specification of input and output, i.e., enumeration of parameters or field descriptors (<parameter or field, format, purpose/meaning, optional/required>), the method of organizing (ordered list, key-value pairs of purpose and value, stringified (unmarshalled) object, etc.). In one embodiment, stack generation method 200 translates the elements of PST 135 for which software is not yet available to a development plan 180. In development plan 180, stack generation method 200 outlines the custom program modules to be created, detailing their specific functionalities, interfaces, dependencies, and how they integrate with other system components, thereby translating the PST 135 into the development plan 180.

In one embodiment, when creating implementation plan 175 and development plan 180, stack generation method 300 determines the functionality of software with reference to a catalogue of existing software (which is a data structure that enumerates and categorizes available software components), as follows. (1) Stack generation method 300 attributes (or correlates) the components to categories of the catalogue of existing software. (2) Stack generation method 300 obtains description of the functionality of components from the PST 135. (3) Stack generation method 300 determines what existing software can fulfill the functionality, in whole or in part. (4) Stack generation method 300 recognizes where unique requirements are unable to be satisfied with the software available in the catalogue of existing software and indicates the need to produce custom software. And, stack generation method 300 may determine dependencies by (i) detecting hierarchical relationships where certain components are to be installed before others; (ii) detecting hierarchical relationships where certain components are to be operational before others; (iii) detecting data flow dependencies where certain components provide data or services to other components; (iv) determine the order in which components are to be initialized; (v) identify operational dependencies where a service or component should be running so that another component may function; and (vi) include dependencies on external systems or services. Further, stack generation method 300 may determine interactions and/or integrations by (i) detecting where software components interconnect, (ii) determining the complexity of integration, (iii) identify where data formats are to be converted between components. These and other items are considered in the creation of implementation plan 175 and development plan 180.

In one embodiment, the steps of block 225 are performed by specification generator 115. At the conclusion of block 225, stack generation method 200 has created a stack specification 160. Stack specification 160 may be used downstream to substantially automate deployment of the solution stack 165 for the software solution to the target computing system 185. Processing continues to end block 230, where stack generation method 200 concludes.

### Further Features of Stack Generation Method

In one embodiment, the PST 135 is a superposition of aspects, such as installation, data flow, functional flow, and availability and performance topologies for the software solution. In one embodiment, stack generation method 200 includes steps to generate these various topologies. Stack generation method 200 includes generating an installation topology that describes locations of software installations in a compute infrastructure for the software solution. Stack generation method 200 includes generating a data flow topology that describes sources and consumers of data in the software solution. Stack generation method 200 includes generating a functional flow topology that describes invocation of tasks in the software solution. And, stack generation method 200 includes generating an availability and performance topology that describes elements to be replicated or clustered in the software solution to achieve the desired availability and/or performance. Note that, when generating component replication/clustering for availability, the LLM may need to consider power boundaries and/or cloud infrastructure availability domains and appropriately distribute the replicas/cluster elements across these power boundaries/availability domains. In another embodiment, stack generation method 200 also includes generating a disaster resilience of critical (as identified by the solution definition) functions or components.

In the case of a software component, the degree of replication is a function of operational requirements vs. known a priori (e.g., from a past benchmark test) software reliability and performance/throughput values. E.g., if the operational requirement is 99.9% availability, and the software reliably supports 99.5%, then the software node should be duplicated, and vice versa, if the requirement is 99% availability, then the single instance of the software component would support it.

If disaster tolerance is among the requirements, then another relevant consideration is geographical distribution of the infrastructure and software components whose operation must be maintained in the case of a disaster. To satisfy disaster tolerance requirement(s), the relevant PST nodes must be enhanced with geographical location of the element, and the infrastructure and software stacks replicated and distributed to multiple locations, presumably not subject to the same disaster. Note that disaster tolerance also requires replication of data flows to ensure availability of data in the case of a disaster.

Different methods of installation may exist for different software components. Installation methods may include custom or built-in installer program (i.e., a program which, while executing, installs the software component), installation from a binary file, source copy (for interpreted languages), or build from source (typically, for compiled languages, such as C and C++). The appropriate method, source entity, and location of the source entity for installation is associated with each software component node of the PST, and the appropriate installation method is used at the time of the software component installation.

Referring now to FIG. 3, in one embodiment, stack generation method 200 includes a software deployment method 300 to automatically deploy software that conforms to implementation plan 175. Software deployment method 300 initiates at start block 305 in response to stack orchestrator 120 determining that it has received (1) an implementation plan 175; (2) an instruction to automatically deploy software that is configured according to the implementation plan 175; or (3) an indication that one or more conditions for performing software deployment method 300 have been satisfied. At block 310, software deployment method 300 executes the deployment specification 170 to automatically configure a target computing system 185 to have compute infrastructure that conforms to the deployment specification 170. For example, software deployment method 300 reads the code (YAML or HCL) of the deployment specification 170, parses the code to identify the infrastructure components that are to be provisioned and configured, and then sets up the infrastructure components in the target computing system 185, allocating resources and applying network settings as specified. At block 315, software deployment method 300 extracts automatable tasks from the implementation plan 175. For example, as discussed below with reference to solution stack generation stage 715, software deployment method 300 detects keywords or patterns in the implementation plan 175 that indicate tasks, extracts sentences or phrases that include the keywords or patterns indicative of the tasks, determines the tasks that are automatable, extracts the details of the automatable tasks, and associates the automatable tasks with a tool for performing the task. At block 320, software deployment method 300 converts the automatable tasks into executable code. For example, the software deployment method 300 accesses and populates a template of code relevant to the task with variables and parameters that specifically set the template to perform to the task. And, at block 325, software deployment method 300 executes the executable code to automatically deploy software that conforms to the implementation plan into the compute infrastructure. For example, software deployment method 300 selects a software tool for performing the task and executes the script with the tool. Software deployment method 300 concludes at end block 330. In one embodiment, the steps of software deployment method 300 are performed using stack orchestrator 120.

Referring now to FIG. 4, in one embodiment, stack generation method 200 includes a custom code generation method 400 to automatically generate custom software that conforms to development plan 180. Custom code generation method 400 initiates at start block 405 in response to stack orchestrator 120 determining that it has received (1) a development plan 180; (2) an instruction to automatically generate software code that satisfies functionality and features specified in the deployment plan 180; or (3) an indication that one or more conditions for performing custom code generation method 400 have been satisfied. At block 410, custom code generation method 400 generates custom software for implementing the software solution from the development plan 180 using the large language model 140. For example, custom code generation method 400 extracts requirements for the custom code from the development plan, populates a template LLM prompt to generate code with the requirements, submits the prompt to an LLM and captures code from the response returned by the LLM. And, at block 415, custom code generation method 400 modifies the implementation plan 175 to include the custom software. In one embodiment, custom code generation method 400 locates a stub (or other placeholder) corresponding to the custom code and replaces the stub with the code captured from the response by the LLM. Custom code generation method 400 concludes at end block 420. In one embodiment, the steps of custom code generation method 400 are performed using stack orchestrator 120 and LLM 140.

Referring now to FIG. 5, stack generation method 200 includes a custom code collection method 500 to automate acquisition of custom software that conforms to development plan 180. Custom code collection method 500 initiates at start block 505 in response to stack orchestrator 120 determining that it has received (1) a development plan 180; (2) an instruction to obtain software code that satisfies functionality, interface, and features specified in the deployment plan 180; or (3) an indication that one or more conditions for performing custom code collection method 500 have been satisfied. At block 510, custom code collection method 500 presents the development plan 180 for review by users. The development plan 180 specifies custom software for implementing the software solution. For example, the development plan is displayed through the user interface 125. At block 515, custom code collection method 500 accepts upload of custom software that conforms to the development plan 180 and supports the specified interface. For example, developers may select an upload code option in the user interface 125, submit custom code for upload, and designate, a stub or other placeholder in the implementation plan 175 that corresponds to the uploaded code (such as by selecting an element of the user interface that indicates the stub). At block 520, custom code collection method 500 modifies the implementation plan 175 to include the custom software, for example as described above with reference to block 415. Custom code collection method 500 concludes at end block 525. In one embodiment, the steps of custom code collection method 500 are performed using stack orchestrator 120 and user interface 125.

Referring now to FIG. 6, stack generation method 200 includes topology validation method 600 for confirming validity of solution topologies. Topology validation method 600 initiates at start block 605 in response to topology generator 110 determining that it has received (1) an LST 155 or PST 135 from LLM 140; (2) an instruction to validate an LST 155 or PST 135; or (3) an indication that one or more conditions for performing topology validation method 600 have been satisfied. At block 610, topology validation method 600 displays at least a portion of the LST 155 or the PST 135 for validation by a user. For example, topology validation method transmits the solution topology (LST 155 or the PST 135) to user interface 125 accompanied by instructions to display the solution topology, and user interface 125 visually displays the solution topology for viewing by the user. In one embodiment, the LST 155 and the PST 135 are represented as collections (such as ordered sequences) of tokens in a GRL. Topology validation method 600 parses the tokens of the LST 155 or PST 135 to identify types of entities (nodes) and relationships (edges) between the entities, assigns to the entities icons (or other graphical representations of nodes) that represent the identified types of the entities, and assigns to relationships styled links (such as color-coded lines, dash patterned lines, and so on) that represent the identified types of the relationships. Topology representation method 600 arranges the icons and links in user interface 125 as specified by the GRL tokens of the LST 155 or PST 135 to display the solution topology.

At block 615, topology validation method 600 accepts input of a correction of the LST 155 or the PST 135. For example, topology validation method 600 accepts entry of edit to the solution topology, and stores the edit as training data for the LLM 140. At block 620, topology validation method 600 re-trains the LLM 140 based on the correction. For example, topology validation method 600 access the edit or correction from the training data and adjusts the behavior of the LLM to better conform to the requirements that resulted in generation of the solution topology. To adjust the behavior of the LLM, values of one or more weights of the LLM may be configured to generate the correction as output. At block 625, topology validation method 600 re-generates the LST 155 or the PST 135 using the re-trained LLM. For example, topology validation method 600 accesses the updated (e.g., re-trained) LLM, reproduces the dynamically-generated prompt, submits the prompt to the updated LLM, and captures or extracts the solution topology from the response by the updated LLM Topology validation method 600 concludes at end block 630. In one embodiment, the steps of topology validation method 600 are performed using topology generator 110 and user interface 125.

### Context and Discussion of LLM-Based Stack Generation

In one embodiment, the stack generation system 100 leverages LLMs to generate a complete solution. The stack generation system 100 generates a technology stack, followed by generating a software stack specification, and generating identifications of custom software, integration, and customization points. In one embodiment, stack generation system 100 does not generate custom software; and in one embodiment, stack generation system 100 further leverages the LLMs to generate code for the custom software based on a development plan. In one embodiment, these steps performed by the stack generation system are incorporated into a feedback loop for user corrections. The feedback loop ensures that the physical infrastructure is in synchronization with the solution definition with respect to infrastructure requirements, capacity, and security.

A software solution can be represented as a graph, referred to herein as a solution graph or, more formally, as a solution topology. A solution topology may include a broad variety of types of nodes. In the solution topology, a node represents an infrastructure element, an installed standard or custom-developed software component, a service, or a collection of data. The solution topology may also have multiple types of edges. In the solution topology, an edge represents an connection between nodes. The type of the edge represents the type of connection between the nodes. There may be multiple edges of multiple types connecting two nodes within a solution topology. In fact, an edge may connect a node to itself. E.g. consider a case where program A and program B are installed and execute on the same node N and communicate via a network, where communication could be represented via an edge between N and N.

A solution topology may be represented at differing levels of abstraction. For example, there may be an LST (logical solution topology) graph which abstracts a PST (physical solution topology) graph. Note, the statement that an LST abstracts (or is an abstraction of) a PST does not imply that there is a pre-existing PST from which the LST is abstracted. As discussed herein, LSTs may be used to inform the creation of PSTs by providing a guiding structure for additional information from solution definition 130.

In one embodiment, types of nodes that can be incorporated in a solution topology include, but are not limited to, infrastructure element nodes, software package nodes, data nodes, and service nodes. The infrastructure element nodes may represent, for example, servers, bastions, load balancers, compute instances, virtual machines, networks and subnetworks, gateways, firewalls or other infrastructure components.

The software package nodes may include nodes for standard software that is available “off-the-shelf” and usable for purposes of the software solution. And, the software package nodes may include nodes for custom software that is specifically created for purposes of the software solution. In one embodiment, a software package represented by a software package node has at least one function, or a set of one or more functions. Optionally, a software package may be configurable or customizable. Optionally, a software package may be connected to or integrated with another element of the software solution. Optionally, a software package may be multiplexed or clustered, for example for purposes of performance or reliability.

The data nodes may be of various types. For example, there may be database nodes, and file nodes. Nodes for other data sources may also be included, such as a streaming node for accessing live, real-time, or otherwise streaming data.

The service nodes are configured to access one or more services, such as an online service.

Various types of edges that can be included in a solution topology are categorized based on the abilities of nodes to interact. In other words, the edge types represent differing types of relationships that occur between nodes. The edge types include, but are not limited to, physical connection edges and network connection edges that are applicable to relationships with infrastructure nodes (also referred to herein as infrastructure edges); interconnection and integration edges that are applicable to relationships with software package nodes, data nodes, and service nodes; invocation edges, which are applicable to invoking, e.g., via REST, of a software package or service by a software package; data flow edges indicating the transmission of information between nodes; peer clustering edges indicating groups of independent nodes that collaborate to achieve a shared goal (such as load balancing, high availability, fault tolerance, and scalability); required edges indicating that one component is needed by another component in order to function properly; and ‘installed on’ edges indicating that one component is installed on another component.

In practice, a PST is a superposition or conglomeration of several independent views of a software solution in a single topology. In one embodiment, a PST includes a view of an installation topology. The installation topology shows where elements of the software solution are installed, and on what entities the elements are installed. In one embodiment, a PST includes a view of a data flow topology. The data flow topology shows what entities use which data sources. In one embodiment, a PST includes a view of a functional flow topology. The functional flow topology shows which entities invoke which other entities. And, in one embodiment, a PST includes a view of an availability and performance topology. The availability and performance topology shows which elements are replicated and/or clustered.

In one embodiment, an LLM may produce each of the above aspects of the solution topology independently. The stack generation system may then join the aspects together into a unified LST and PST. Alternatively, an LLM may be instructed to keep each aspect separate. The stack generation system may then represent the LST and PST as collections of different types of graphs covering the distinct aspects of the solution. In one embodiment, the choice of whether the LLM is to produce unified (i.e., superposition) solution topologies, or discrete topologies for the various aspects (or both) may be a setting pre-set by the user, for example by entering the selection through user interface 125.

In one embodiment, when using an LLM to generate LST and PST, technology standards and skills of the solution team are of importance. The technology standards and skills of the solution team may be included in the solution definition. Given a choice of multiple products with identical or similar functions, the technology standards and team skills guide the LLM generation towards products that fall within the technology standards and skill set of the team.

Whether represented as a collection of separate graphs or a unified (superposition) graph, the PST can be translated to a solution implementation, as well as other parts of a stack specification. In one embodiment, the translation into the solution implementation plan starts with the installation steps, followed by customization steps, then by integration steps, and finally by custom software implementations (created in response to a development plan).

### Example Stack Generation Process

FIG. 7 illustrates one embodiment of a stack generation process 700 that is associated with generation and deployment of solution stacks for software solutions using LLMs. Stack generation process 700 includes three stages: an LST generation stage 705, a PST generation stage 710, and solution stack generation stage 715.

In one embodiment, LST generation stage 705 uses an LST LLM 720 to generate an LST 725 (such as LST 155) from LST requirements 730. LST generation stage 705 extracts LST requirements 730 from the solution definition 130. For example, LST generation stage 705 parses the solution definition to identify and retrieve the LST requirements 730: portions of the solution definition that are relevant to generating an LST. The parsing may be performed using natural language processing techniques, keyword and pattern matching, or other techniques for determining the LST requirements. The LST requirements 730 include functional requirements of the software solution, technology standards, and available skills of the solution team.

In one embodiment, LST generation stage 705 dynamically generates an LST generation prompt—an LLM prompt that includes the LST requirements 730 and instructions to generate an LST based on the LST requirements 730. For example, LST generation stage 705 may dynamically generate the LST generation prompt by populating a template prompt with the LST requirements 730. LST generation stage 705 submits the LST generation prompt to LST LLM 720. LST LLM 720 generates a response to the LST generation prompt. LST generation stage 705 captures the response to the prompt from LST LLM 720. LST generation stage 705 parses the captured response to extract the LST 725.

LST generation stage 705 then performs an LST validation 735 to detect errors (LST validation errors 740), if any, in LST 725. In one embodiment, LST validation 735 causes LST 725 to be displayed (e.g., using user interface 125) for review by a user. LST validation 735 requests input of LST validation errors 740, if any, and corresponding corrections by the user. LST validation errors 740 may be input by recording user addition, removal, or editing of entities in LST 725. The LST validation errors 740 and corresponding corrections (if any) are thus captured and stored for future reference.

Decision block 745 checks to see whether LST 725 is determined to be valid or not, for example based on, respectively, the absence or presence of LST validation errors 740. Where there are no LST validation errors 740 in LST 725, LST 725 is valid (block 745: YES) and example stack generation process 700 proceeds to PST generation stage 710. Where one or more LST validation errors 740 is present in LST 725, LST 725 is invalid (block 745: NO), and LST generation stage 705 adds the LST validation errors 740 and their corresponding corrections to LST LLM training data 750. The corrections collected during LST validation 735 may then be used to re-train LST LLM 720 to mitigate the errors and improve accuracy of subsequent LST generation. LST generation stage 705 may then be retried with the re-trained LST LLM 720 until the resulting LST 725 is determined to be valid.

In one embodiment, retraining of the LST LLM 720 may be performed by prompt engineering. For example, corrections collected during LST validation 735 may be included in a dynamically generated prompt that establishes, modifies, or cancels a rule, such as “In the topologies that you generate in the future” The dynamically generated prompt may then be automatically injected into the LST LLM 720, thereby adjusting the behavior of the LST LLM 720.

In one embodiment, retraining of the LST LLM 720 may be performed by fine-tuning. For example, the corrections are used as training data in a further epoch of LST LLM training 755. LST LLM training adjusting weights of the LST LLM 720 in accordance with the corrections to cause LST LLM 720 to generate LSTs that better conform to the LST requirements 730, thereby adjusting the behavior of the LST LLM 720.

In one embodiment, PST generation stage 710 uses a PST LLM 760 to generate a PST 765 (such as PST 135) from PST requirements 770 and validated LST 725. In one embodiment, PST 765 is a superposition graph including multiple aspects of the PST. In one embodiment, PST 765 is made up of separate PSTs specific to the various aspects of the PST 765. PST generation stage 710 extracts PST requirements 770 from the solution definition 130. For example, PST generation stage 710 parses the solution definition to identify and retrieve the PST requirements 770. The parsing may be performed using natural language processing techniques, keyword and pattern matching, or other techniques for identifying the PST requirements 770. The PST requirements 770 include non-functional requirements of the software solution, such as routing and filtering, capacity, performance and response time, and availability requirements.

In one embodiment, PST generation stage 710 dynamically generates a PST generation prompt—an LLM prompt that includes LST 725, PST requirements 770, and instructions to generate a PST based on LST 725 and PST requirements 770—for example by populating a template prompt with the LST 725 and PST requirements. PST generation stage 710 submits the PST generation prompt to PST LLM 760. PST LLM 760 generates a response to the PST generation prompt. PST generation stage 710 captures the response to the prompt from PST LLM 760. PST generation stage 710 parses the captured response to extract the PST 765.

PST generation stage 710 then performs a PST validation 775 to detect errors (PST validation errors 779), if any, in PST 765, in a manner substantially similar to that described above with reference to LST validation 735. Decision block 777 checks whether PST 765 is or is not valid based on the absence or presence, respectively, of PST validation errors 779. Where there are no PST validation errors 779, PST 765 is valid (block 777: YES), and example stack generation process 700 proceeds to solution stack generation stage 715. Where there are PST validation errors 779, PST 765 is invalid (block 777: NO), and PST generation stage 710 adds the PST validation errors 779 and corresponding corrections supplied during PST validation 775 to PST LLM training data 781. The updated PST LLM training data 781. The corrections may then be used to retrain PST LLM 760 in a manner substantially similar to that described above with reference to retraining of LST LLM 720, for example by prompt engineering or by fine-tuning. PST generation stage 710 may be retried with the retrained PST LLM 760 until the resulting PST 765 is determined to be valid.

In one embodiment, LST LLM 720 is an LLM (such as LLM 140) that is configured to generate an LST in GRL code when provided with LST requirements such as functional requirements of the software solution, technology standards, and available skills or expertise of the solution team. In one embodiment, PST LLM 760 is an LLM (such as LLM 140) that is configured to generate a PST in a GRL when provided with an LST and PST requirements such as routing and filtering, capacity, performance and response time, and availability specifications for the software solution. In one embodiment, LST LLM 720 is an LLM dedicated to generation of LSTs, and PST LLM 760 is an LLM dedicated to generation of PSTs. In another embodiment, LST LLM 720 and PST LLM 760 are one LLM (such as LLM 140) used to generate both LSTs and PSTs.

Upon receiving a prompt, the LLM (LST LLM 720 or PST LLM 760) tokenizes and embeds the prompt. Tokenization splits the strings of text that make up a prompt into smaller units such as words, subwords, or characters, that represent basic elements of a language, such as the human language used in the solution definition and its component LST requirements 720 and PST requirements 770. Embedding converts the tokens into vectors in a multi-dimensional space that captures semantic meaning—underlying concepts conveyed by the tokens in view of context—of the tokens. Example embedding models that may be used for embedding tokens include, but are not limited to Word2Vec, GloVe, FastText, BERT (Bidirectional Encoder Representations from Transformers), ELMo (Embeddings from Language Models), GPT (Generative Pre-trained Transformer), and Universal Sentence Encoder. Other embedding models, including domain-specific and proprietary embedding models may also be appropriate. The LLM then applies attention mechanisms (including one or more attention heads) to focus on portions of the prompt that inform the creation of a solution topology. The attention heads determine an importance to creation of the solution topology of individual tokens in context of the sequence of embedded tokens from the prompt.

In one embodiment, solution stack generation stage 715 automatically translates the validated PST 765 into a stack specification 160. The stack specification 160 may include a deployment specification 170 for automated creation or configuration of infrastructure. For example, translate PST 785 translates the PST 765 into a deployment specification 170, such as Ansible deployment code 787 (written in YAML (YAML Ain't Markup Language)) or Terraform deployment code 789 (written in HashiCorp Configuration Language (HCL)).

The stack specification 160 may include a solution implementation plan 175 for configuring the software solution atop the infrastructure. The solution implementation plan 175 may be in human language. The solution implementation plan 175 may be parsed to extract automatable tasks. The extraction of automatable tasks may be performed by pattern matching techniques. Or, the extraction of automatable tasks may be performed by an LLM.

When extracting automatable tasks by pattern recognition, the extraction process may search the solution implementation plan 175 to detect action verbs indicating tasks, such as “install,” “configure,” “deploy,” “update,” “backup,” “start,” “stop,” and so on. In one embodiment, the extraction process may perform pattern recognition (e.g., using regular expressions or pattern matching) on the solution implementation plan 175 to detect sentences that fit task structures. The extraction process may search the solution implementation plan 175 to detect modality indicators such as “must,” “should,” “shall,” “required”, and so on that designate mandatory tasks. The extraction process then extracts sentences or phrases that represent discrete tasks detected by one or more of the detection tests above.

When extracting automatable tasks by LLM, the LLM has been trained to recognize particular verbs as indicative of tasks, and to recognize particular modality indicators as designating that tasks are mandatory. The solution implementation plan 175 may be provided to the LLM in a prompt instructing the LLM to (1) extract the tasks, and (2) label the extracted tasks with a status of whether the task is mandatory. The LLM may then analyze the solution implementation plan 175 to (1) identify phrases that includes an embedding(s) similar to the verbs as discrete tasks, and (2) label the tasks as mandatory where the phrase identified as the task includes an embedding(s) similar to the modality indicators. The LLM may then return (1) a description of the identified task(s) and (2) a status indicating whether the individual task is mandatory.

The extraction process then classifies the tasks as automatable—tasks that can be executed by software with low to no human intervention—or non-automatable—tasks that employ human judgment. For example, the tasks that can be executed by software can expressed with a limited set of generalized directives (referred to as primitives), such as (1) provision infrastructure, (2) obtain software <from a repository, or some other source, purchase, access a service>, (3) install software, (4) customize/configure software, (5) integrate software A with software B, or (6) develop software (e.g., fill in a gap in the available functionalities). The automatable tasks may be expressed as sequences of these primitives that have been populated with the relevant details. The classification of the tasks may be based on keywords (e.g., “install,” “configure,” “deploy,” etc. indicate automatable tasks, while “review,” “approve,” “design,” etc. indicate non-automatable tasks). The classification may also be based on pattern matching or may be based on grammatical dependency from subjects indicating automation such as “script” or “system.” The classification may also be performed by machine learning models, including by the LLM 140 (in response to a prompt to classify the tasks as one of automatable or non-automatable), or by a dedicated classification model that is trained to perform the classification of tasks as automatable or not.

The extraction process then extracts the details of the automatable tasks. For example, the components, configurations, dependencies, sequencing, resources, environments, and constraints involved are captured and stored for downstream use. In one embodiment, where task extraction is performed by the LLM, the tasks may be extracted as populated primitives that already include the details of the automatable tasks. The extraction process then maps the automatable tasks to the automation tools for performing the tasks. For example, configuration tasks may be mapped to configuration management tools such as Ansible; orchestration tasks may be mapped to orchestration tools such as Kubernetes or Docker Compose; CI/CD tasks may be mapped to CI/CD tools such as Hudson or Jenkins.

Automatable tasks may include installing and configuring software components (such as existing, off-the-shelf applications, code libraries, functions, as well as custom software), setting environment variables, setting application configurations, defining workflows, performing test suites and validation checks, and a wide variety of other actions. Many of these may be performed to set up deployable containers (such as a Docker container) for components of the software solutions. The automatable processes may be converted to appropriate executables, such as scripts or binary executable files. Note, in one embodiment, installation and configuration of software components may leave placeholders or stubs for custom code.

For example, automatable processes for container orchestration may use YAML or JSON (JavaScript Object Notation) files to define deployment configurations for containers in Kubernetes or Docker Swarm. Or, for example, automatable processes for continuous integration (CI) and continuous deployment (CD) pipelines may be configured in Hudson, Jenkins, GitLab CI/CD, Azure DevOps, or other CI/CD tools to automate build, test, and deployment processes. In another example, definition and implementation of orchestration workflows that sequence tasks in an order that correctly accounts for dependencies and conditions may also be an automatable process. These workflows may be defined in YAML, such as in Kubernetes manifests, Ansible playbooks, Docker compose files, Oracle Cloud Infrastructure (OCI) DevOps Service pipelines, Azure pipelines; in JSON, such as in OCI command line interface and APIs, Amazon Web Services (AWS) cloud formation templates, Azure Resource Manager (ARM) templates, Google cloud deployment manager; in HCL for use with Terraform.

The scripts or other executables for performing the automatable tasks may be automatically generated. In one embodiment, the script generation process accesses a template or boilerplate code relevant to the task. The script generation process then populates the template or boilerplate code with specific parameters and variables to customize the template or boilerplate code to perform the task.

The stack specification 160 may include a development plan 180 for creation of custom software. The development plan 180 is generated to include clear and detailed functional and non-functional requirements for the custom software. The development plan 180 thus describes intended behaviors, algorithms, code languages, and structures of the custom software. In one embodiment, solution stack generation stage 715 is configured to parse the development plan to extract the requirements for the custom software. The requirements for individual functions or modules are collected discretely, that is, gathered separately from the requirements of other functions.

Solution stack generation stage 715 is configured to dynamically generate prompt to an LLM that is configured to cause the LLM to generate an individual function based on the requirements for the individual function. In one embodiment, the prompt is generated by populating a template prompt, such as “Generate code for a function that satisfies the following requirements: [Requirements]. Include comments at individual lines of code that describe the operations performed by the line.” The prompt may structure the requirements so as to describe the function with bullet points, numbered lists, or pseudo-code to guide the LLM. The prompt may further separate out the chosen coding language from the requirements.

Solution stack generation stage 715 is configured to submit the prompt to the LLM to cause generation of the code for the function, and to capture the response by the LLM. Solution stack generation stage 715 extracts the code for the function from the response and stores it for subsequent processing. The code for the function is presented for review and validation by a user, for example in user interface 125. The user may edit and approve the code for the function. Or the user may reject the code and provide corrective feedback as a prompt to cause the LLM to revise and correct the code in an iterative, human-in-the-loop refinement process. Upon approval, solution stack generation stage 715 may add the custom code for the function to the solution implementation plan 175 as software for testing and/or deployment. For example, solution stack generation stage 715 may add insert the custom code for the function into the solution implementation plan 175 by replacing a stub or placeholder that corresponds to the function.

Once the custom code is in place in solution implementation plan 175, subject to testing and approval, stack orchestrator 120 may automatically deploy software onto infrastructure that has been deployed (in accordance with the deployment specification 170) into a target computing system. For example, containers associated with individual infrastructure nodes are constructed and delivered to the associated infrastructure node for execution. In this way, solution stack 165 is deployed into the target computing system 185.

### Example LLM Training

In one embodiment, the LST LLM 720 and PST LLM 760 each undergo a training process. LST LLM training 755 trains LST LLM 720 to generate LSTs from LST requirements 730 based on an LST training dataset of training materials, LST LLM training data 750. PST LLM training 783 trains PST LLM 760 to generate PSTs from LSTs and PST requirements 770 based on a PST training dataset of training materials, PST LLM training data 781.

In one embodiment, LST LLM training 755 for the LST LLM 720 and PST LLM training 783 for PST LLM 760 is based on an accumulation of previously defined example LST and PST graphs that are accepted as valid representations of associated example requirements. The examples may be historical records from stack generation projects that were previously completed satisfactorily. For example, a cloud provider or cloud client may maintain a database of software solution stacks—including associated solution definitions, LSTs, and PSTs—that are deemed to be correct, and therefore provide a rich source of training data.

The example LSTs and PSTs may be represented as collections of tokens (i.e., in a GRL). The example requirements may be formatted as human language, such as human language text. The LST training materials (LST LLM training data 755) for LST LLM 720 include pairs of LST requirements and corresponding LSTs resulting from the LST requirements. The PST training materials (PST LLM training data 783) for PST LLM 760 include triplets of PST requirements, corresponding LITs, and corresponding PSTs resulting from the PST requirements and LITs.

In one embodiment, a training process (such as LST LLM training 755 or PST LLM training 783) is configured to train an LLM 140 (such as LST LLM 720 or PST LLM 760) by iteratively feeding associated tuples of training data of a training batch into the LLM 140 that is set to a training mode. For example, the tuples of training data may be (a) pairs of example LST requirements and associated example LST for training with respect to LST generation, or (b) triplets of example PST requirements, associated example LST, and associated example PST for training with respect to PST generation. The training teaches the LLM 140 the mappings between example LST requirements and GRL code for an example LST and teaches the LLM 140 the mappings from example PST requirements and GRL code of an example LST to GRL code for an example PST.

The training process adjusts parameters of the LLM 140 to reduce error or loss (a) between example LST requirements and GRL code for an example LST, and (b) from example PST requirements and GRL code of an example LST to GRL code for an example PST. During the training process, parameters related to tokenization, size of the vector embeddings, and number of attention heads may be tuned or adjusted to improve results. As discussed above, after initial training, the training of the LLM 140 may be updated by fine-tuning to adjust the model based on feedback from validation processes (such as LST validation 735 and PST validation 775), in which errors in generated topologies are identified and corrected.

### Cloud or Enterprise Embodiments

In one embodiment, the present system (such as stack generation system 100) is a computing/data processing system including a computing application or collection of distributed computing applications for access and use by other client computing devices that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, stack generation system 100 is a centralized server-side application that provides at least the functions disclosed herein and that is accessed by many users by way of computing devices/terminals communicating with the computers of stack generation system 100 (functioning as one or more servers) over a computer network. In one embodiment stack generation system 100 may be implemented by a server or other computing device configured with hardware and software to implement the functions and features described herein.

In one embodiment, the components of stack generation system 100 may be implemented as sets of one or more software modules executed by one or more computing devices specially configured for such execution. In one embodiment, the components of stack generation system 100 are implemented on one or more hardware computing devices or hosts interconnected by a data network. For example, the components of stack generation system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of stack generation system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of stack generation system 100 may (i) generate or compose an electronic message or signal to issue a command or request to another component, (ii) transmit the message or signal to other components of stack generation system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by stack generation system 100, for example through a web interface server. In one embodiment, the remote computing system may send requests to and receive responses from stack generation system 100. In one example, access to the information or applications may be effected through use of a web browser on a personal computer or mobile device. In one example, communications exchanged with stack generation system 100 may take the form of remote representational state transfer (REST) requests using JavaScript object notation (JSON) as the data interchange format for example, or simple object access protocol (SOAP) requests to and from XML servers. The REST or SOAP requests may include API calls to components of stack generation system 100.

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

### Computing Device Embodiment

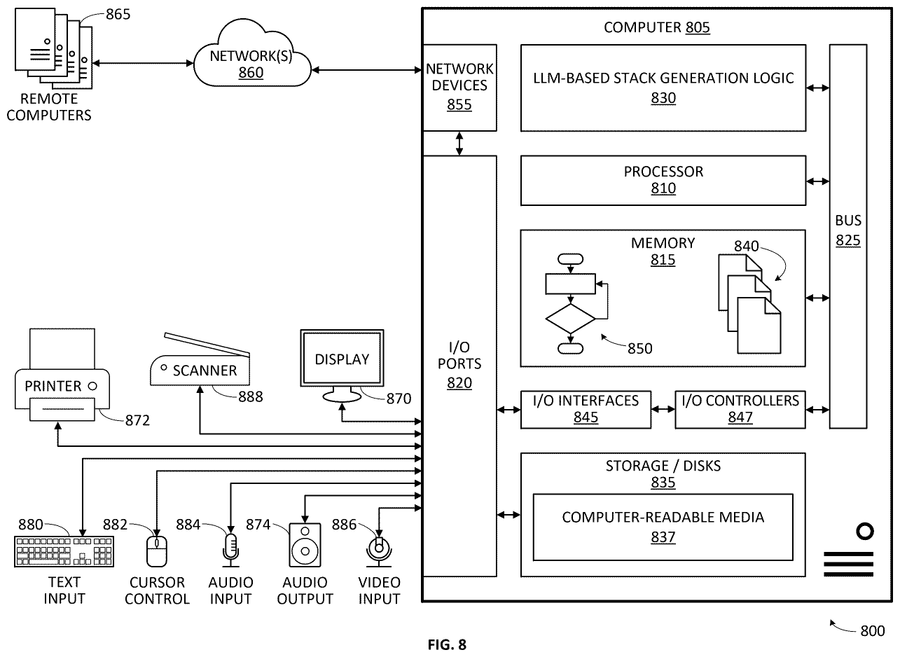

FIG. 8 illustrates an example computing system 800 that is configured and/or programmed as a special purpose computing device(s) with one or more of the example systems and methods described herein, and/or equivalents. The example computing device may be a computer 805 that includes at least one hardware processor 810, a memory 815, and input/output ports 820 operably connected by a bus 825. In one example, the computer 805 may include LLM-based stack generation logic 830 configured to facilitate generation and deployment of solution stacks for software solutions using LLMs, similar to the logic, systems, methods, and other embodiments shown in and described with reference to FIGS. 1-7.

In different examples, the logic 830 may be implemented in hardware, one or more non-transitory computer-readable media 837 with stored instructions, firmware, and/or combinations thereof. While the logic 830 is illustrated as a hardware component attached to the bus 825, it is to be appreciated that in other embodiments, the logic 830 could be implemented in the processor 810, stored in memory 815, or stored in disk 835.

In one embodiment, logic 830 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate generation and deployment of solution stacks for software solutions using LLMs. The means may also be implemented as stored computer executable instructions that are presented to computer 805 as data 840 that are temporarily stored in memory 815 and then executed by processor 810.

Logic 830 may also provide means (e.g., hardware, non-transitory computer-readable medium that stores executable instructions, firmware) for performing one or more of the disclosed functions and/or combinations of the functions.

Generally describing an example configuration of the computer 805, the processor 810 may be a variety of various processors including dual microprocessor and other multi-processor architectures. A memory 815 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 835 may be operably connected to the computer 805 via, for example, an input/output (I/O) interface (e.g., card, device) 845 and an input/output port 820 that are controlled by at least an input/output (I/O) controller 847. The disk 835 may be, for example, a magnetic disk drive, a solid-state drive, a floppy disk drive, a tape drive, a Zip drive, a flash memory card, a memory stick, and so on. Furthermore, the disk 835 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 815 can store a process 850 and/or a data 840, for example. The disk 835 and/or the memory 815 can store an operating system that controls and allocates resources of the computer 805.

The computer 805 may interact with, control, and/or be controlled by input/output (I/O) devices via the input/output (I/O) controller 847, the I/O interfaces 845, and the input/output ports 820. Input/output devices may include, for example, one or more network devices 855, displays 870, printers 872 (such as inkjet, laser, or 3D printers), audio output devices 874 (such as speakers or headphones), text input devices 880 (such as keyboards), cursor control devices 882 for pointing and selection inputs (such as mice, trackballs, touch screens, joysticks, pointing sticks, electronic styluses, electronic pen tablets), audio input devices 884 (such as microphones or external audio players), video input devices 886 (such as video and still cameras, or external video players), image scanners 888, video cards (not shown), disks 835, and so on. The input/output ports 820 may include, for example, serial ports, parallel ports, and USB ports.

The computer 805 can operate in a network environment and thus may be connected to the network devices 855 via the I/O interfaces 845, and/or the I/O ports 820. Through the network devices 855, the computer 805 may interact with a network 860. Through the network 860, the computer 805 may be logically connected to remote computers 865. Networks with which the computer 805 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computing system cause the computing system to:
access a solution definition for a software solution, wherein the solution definition is in human language;
generate a logical solution topology from the solution definition using a large language model;
generate a physical solution topology from the solution definition and the logical solution topology using the large language model; and
translate the physical solution topology into a stack specification that describes a solution stack for creation and implementation of the software solution, wherein the stack specification includes a deployment specification, an implementation plan, and a development plan.

2. The one or more non-transitory computer readable media of claim 1, wherein the physical solution topology is a superposition of installation, data flow, functional flow, and availability and performance topologies for the software solution.

3. The one or more non-transitory computer readable media of claim 1, further comprising instructions that when executed by at least the processor cause the computing system to:
execute the deployment specification to automatically configure a target computing system to have compute infrastructure that conforms to the deployment specification;
extract automatable tasks from the implementation plan;
convert the automatable tasks into executable code; and
execute the executable code to automatically deploy software that conforms to the implementation plan into the compute infrastructure.

4. The one or more non-transitory computer readable media of claim 1, further comprising instructions that when executed by at least the processor cause the computing system to:
generate custom software for implementing the software solution from the development plan using the large language model; and
modify the implementation plan to include the custom software.

5. The one or more non-transitory computer readable media of claim 1, further comprising instructions that when executed by at least the processor cause the computing system to:
present the development plan for review by users, wherein the development plan specifies custom software for implementing the software solution;
accept upload of custom software that conforms to the development plan; and
modify the implementation plan to include the custom software.

6. The one or more non-transitory computer readable media of claim 1, further comprising instructions that when executed by at least the processor cause the computing system to:
display at least a portion of the logical solution topology or the physical solution topology for validation by a user;
accept input of a correction of the logical solution topology or the physical solution topology;
re-train the large language model based on the correction; and
re-generate the logical solution topology or the physical solution topology using the re-trained large language model.

7. The one or more non-transitory computer-readable media of claim 1, wherein the logical solution topology and the physical solution topology are represented as collections of tokens in a graph representation language.

8. A computer-implemented method, comprising:
accessing a solution definition for a software solution, wherein the solution definition is in human language;
generating a logical solution topology from the solution definition using a large language model;
generating a physical solution topology from the solution definition and the logical solution topology using the large language model; and
translating the physical solution topology into a stack specification that describes a solution stack for creation and implementation of the software solution, wherein the stack specification includes a deployment specification, an implementation plan, and a development plan.

9. The computer-implemented method of claim 8, wherein generating the physical solution topology further comprises:
generating an installation topology that describes locations of software installations in a compute infrastructure for the software solution;
generating a data flow topology that describes sources and consumers of data in the software solution;
generating a functional flow topology that describes invocation of tasks in the software solution; and
generating an availability and performance topology that describes elements to be replicated or clustered in the software solution.

10. The computer-implemented method of claim 8, further comprising:
displaying at least a portion of the logical solution topology or the physical solution topology for validation by a user;
accepting input of a correction of the logical solution topology or the physical solution topology;
re-training the large language model based on the correction; and
re-generating the logical solution topology or the physical solution topology using the re-trained large language model.

11. The computer-implemented method of claim 8, further comprising:
executing the deployment specification to automatically configure a target computer system to have compute infrastructure that conforms to the deployment specification;
extracting automatable tasks from the implementation plan;
converting the automatable tasks into executable code; and
executing the executable code to automatically deploy software that conforms to the implementation plan into the compute infrastructure.

12. The computer-implemented method of claim 8, further comprising:
generating custom software for implementing the software solution from the development plan using the large language model; and
modifying the implementation plan to include the custom software.

13. The computer-implemented method of claim 8, further comprising:
presenting the development plan for review by users, wherein the development plan specifies custom software for implementing the software solution;
accepting upload of custom software that conforms to the development plan; and
modifying the implementation plan to include the custom software.

14. The computer-implemented method of claim 8, wherein the logical solution topology and the physical solution topology are represented as collections of tokens in a graph representation language.

15. A computing system, comprising:
a processor;
a memory;
one or more non-transitory computer-readable media that include stored thereon computer-executable instructions that, when executed by at least the processor, cause the computing system to:
access a solution definition for a software solution, wherein the solution definition is in human language;
generate a logical solution topology from the solution definition using a large language model;
generate a physical solution topology from the solution definition and the logical solution topology using the large language model;
translate the physical solution topology into a stack specification that describes a solution stack for creation and implementation of the software solution, wherein the stack specification includes a deployment specification, an implementation plan, and a development plan; and
orchestrate deployment of the solution stack to a target computing system to configure the target computing system to execute the software solution.

16. The computing system of claim 15, wherein the physical solution topology is a superposition of installation, data flow, functional flow, and availability and performance topologies for the software solution.

17. The computing system of claim 15, wherein the instructions further comprise instructions that when executed by at least the processor cause the computing system to:
display at least a portion of the logical solution topology or the physical solution topology for validation by a user;
accept input of a correction of the logical solution topology or the physical solution topology;
initiate a re-training of the large language model based on the correction; and
re-generate the logical solution topology or the physical solution topology using the re-trained large language model.

18. The computing system of claim 15, wherein the instructions to orchestrate deployment of the solution stack to the target computing system further comprise instructions that when executed by at least the processor cause the computing system to:
execute the deployment specification to automatically configure the target computer system to have compute infrastructure that conforms to the deployment specification;
extract automatable tasks from the implementation plan;
convert the automatable tasks into executable code; and
execute the executable code to automatically deploy software that conforms to the implementation plan into the compute infrastructure.

19. The computing system of claim 15, wherein the instructions to orchestrate deployment of the solution stack to the target computing system further comprise instructions that when executed by at least the processor cause the computing system to:
generate custom software for implementing the software solution from the development plan using the large language model; and
modify the implementation plan to include the custom software.

20. The computing system of claim 15, wherein the instructions further comprise instructions that when executed by at least the processor cause the computing system to:
present the development plan for review by users, wherein the development plan specifies custom software for implementing the software solution;
accept upload of custom software that conforms to the development plan; and
modify the implementation plan to include the custom software.
